(19) United States
(12) Patent Application Publication
(10) Pub. No.: US 2005/0267802 A1
(43) Pub. Date: Dec. 1, 2005

(54) Receiving fees in response to consumer purchase of item associated with product and in response to consumer purchase of product using item

(76) Inventor: Andrew R. Ogren, Woodbury, MN (US)

Correspondence Address: PRATT & WHITNEY, 400 MAIN STREET, MAIL STOP: 132-13, EAST HARTFORD, CT, 06108, US

(21) Appl. No.: 10/857,299

(22) Filed: May 29, 2004

(51) Int. Cl. G06F 17/60

(52) U.S. Cl. 705/14

(57) ABSTRACT

A method of an embodiment provides an establishment with an item associated with a product. The item may be an electronically readable point-of-sale (POS) card. Examples of products include travel-related products and services such as airplane flights, hotel room rentals, and car rentals. The item may represent a discounted price of the product. For instance, the item can represent a discount on the purchase price of the product from a provider, or it can represent a purchase price that is less than a regular purchase price of the product. The party providing the establishment with the item can receive fees in two different ways. First, when the consumer purchases the item from the establishment, and when the item is activated, the party receives a fee from the establishment. Second, when the consumer purchases the product from the provider using the item, the party receives a fee from the provider.

### FIELD OF THE INVENTION

The present invention relates generally to discount-type items, such as discount-type cards available at point-of-sale (POS), and more particularly to the party providing the discount-type items receiving fees when consumers purchase them, and also when consumers use the items for purchasing products associated with the items.

### BACKGROUND OF THE INVENTION

Historically, consumers have made travel reservations using travel agents. Types of travel reservations include airplane ticket purchases, car rental reservations, hotel reservations, cruise ship reservations, as well as other types of travel reservations. A consumer would call up a travel agent, who would make the necessary plans for the consumer. The travel agents usually receive a percentage commission directly from the travel operators.

More recently, consumers have been able to make their travel reservations directly over the Internet. Internet web sites operated by such companies as Expedia, Inc., of Bellevue, Wash., allow consumers to directly book flights, car rentals, and hotel rooms without using travel agents. At first, travel operators welcomed consumer usage of these travel web sites, as the operators generally pay less in commission to the companies operating travel web sites than they do to travel agents. However, with travel-related product profit margins decreasing, the travel operators have begun to view the payments made to travel web sites offering one-stop shopping for travel-related products as a cost to be decreased.

Therefore, most airlines, car rental companies, and hotel operators now run their own web sites. Although such web sites have observed a degree of success, many consumers view browsing the one-stop shopping travel web sites, such as Expedia.com, as more convenient than browsing individual travel operator web sites. A consumer wishing to determine air fare prices, for instance, may be able to see the prices offered by many different airlines at a one-stop shopping travel web site. By comparison, at a web site run by an airline itself, the consumer usually can find fares from only that airline.

Furthermore, web sites run by the individual travel operators are not typically as broad in their offerings as one-stop shopping travel web sites are. For instance, a traveler looking to book an airplane flight, a hotel, and a rental car may have to visit at least three different web sites: a web site run by an airline, a web site run by a hotel operator, and a web site run by a car rental company. If the traveler wishes to price a number of different airlines, hotel operators, and car rental companies, he or she will have to visit that many more different web sites. By comparison, a one-stop shopping travel web site offers the traveler the ability to make all his or her travel plans, as well as to comparison shop, by visiting a single web site.

Therefore, there has been little incentive for consumers to visit the web sites run by the individual travel operators as opposed to one-stop shopping travel web sites. Some individual travel operators offer slightly cheaper air fares, car rental rates, and so on, than the one-stop shopping travel web sites do, but many consumers are unaware of these less-expensive offerings. For these and other reasons, individual travel operators have not been as successful as they had originally hoped in having consumers make their travel plans on their own web sites, as opposed to on one-stop shopping travel web sites.

### SUMMARY OF THE INVENTION

A method of an embodiment of the invention includes providing an establishment with an item associated with a product. The item may be an electronically readable point-of-sale (POS) card. The term products as used herein encompasses services as well, and examples of such products and services include travel-related products and services such as airplane flights, hotel room rentals, car rentals, and so on. The item may represent a discounted price of the product. For instance, the item can represent a discount on the purchase price of the product from a provider, such as 15% off the regular price of airfare for an airplane flight, as one example. Further, the item can represent a purchase price that is less than a regular purchase price of the product, such as $100-worth of airfare where the consumer only pays $50 for the item, as one example.

The party providing the establishment with the item receives fees in two different ways in one embodiment of the invention. First, when the consumer purchases the item from the establishment, and when the item is activated, the party receives a first fee from the establishment. The establishment may be a retail establishment, such as a department store, convenience store, and so on. The item in one embodiment is activated at the retail establishment. Second, when the consumer purchases the product from the provider using the item, the party receives a second fee from the provider. The consumer may purchase the product from a web site operated by the provider, for instance, or by calling a telephone number of the provider. The provider may be the airline operating the flights that can be purchased using the card, the car rental company offering the car rentals that can be purchased using the card, and so on.

Embodiments of the invention provide for advantages over the prior art. Establishments have an incentive to offer the items for sale, because the items may be provided to the establishments on a consignment basis. As a result, the establishments do not tie up resources in purchasing the cards to offer for sale to their customers. When a customer purchases one of the items, the establishment collects the purchase price, and returns a percentage of the purchase price of the item to the party providing the items as the first fee. There is thus little to no risk incurred by the establishments in selling the cards.

Furthermore, the providers of the products associated with the items have an incentive to have their products be the subject of such items. The providers can specify that the items can be redeemed only directly through their own Internet web sites, for example. Where the discount provided by the items, and the fee that the providers pay to the party providing the card, is less than what the providers would normally pay to a travel agent or a one stop-shopping travel web site, consumer usage of the items in purchasing the providers' products still results in a net revenue increase for the providers. Furthermore, the consumers may become more accustomed to using the web sites of the providers, resulting in subsequent visits to purchase travel-related products directly from the travel providers, even without using items such as POS discount cards.

Therefore, embodiments of the invention provide travel providers, such as airplane flight operators, hotel room operators, and car rental companies, with a way to drive traffic directly to their own web sites, and in doing so, to increase their net revenue. The embodiments of the invention provide retailers and other establishments with a new revenue stream. In addition, the embodiments of the invention provide the party offering the POS discount cards or other items with a unique business model in which revenue and profits are realized by offering such cards. Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method for selling a discount card associated with a product, and activating the discount card, such that the party providing the discount card receives a fee from the establishment selling the card, according to an embodiment of the invention.

FIG. 2 is a flowchart of a method for purchasing the product associated with the discount card by using the discount card, such that the party providing the discount card receives a fee from the provider of the product, according to an embodiment of the invention.

FIGS. 3A and 3B are diagrams of the front and back, respectively, of a representative point-of-sale (POS) card that can act as the item associated with a product offered by a provider, according to an embodiment of the invention.

FIG. 4 is a diagram of an overall system including an establishment point-of-sale (POS) terminal, a product provider computer system, and a computer system of the party providing the discount card, according to an embodiment of the invention.

FIG. 5 is a block diagram of a representative computer system that can be used to implement any of the computer systems of the system of FIG. 3, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

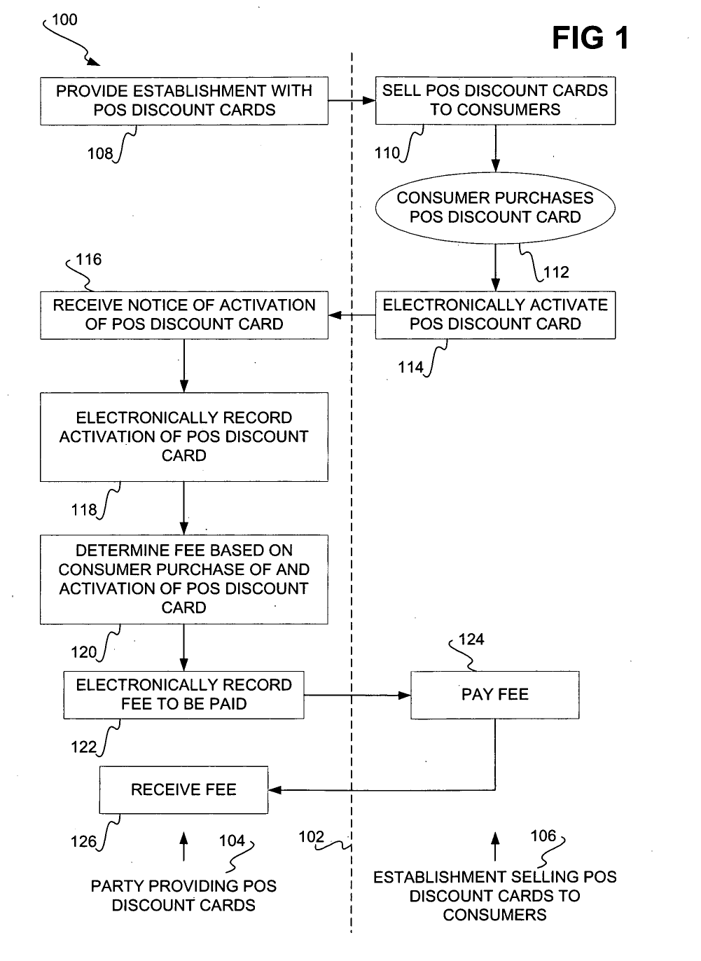

FIG. 1 shows a method 100 by which a consumer purchases a point-of-sale (POS) discount card provided by a party and sold to the consumer by an establishment, according to an embodiment of the invention. The POS discount card is more generally a POS discount item, where a card is one type of item that the consumer may be able to purchase. The card is associated with a product offered by a provider. For instance, the provider can in one embodiment be a travel product and/or service-related provider, such as an airline, a rental car company, a hotel room operator, a cruise operator, and so on. The term product as used herein encompasses both products and services. Examples of such products and services include travel-related products and services, such as airplane tickets and reservations, rental car reservations and rentals, hotel room reservations and rentals, and cruise tickets and reservations. Furthermore, in one embodiment, the POS discount item can encompass more than one such item, such as more than one such POS discount card, where each particular card may be a different or the same discount associated with a different or the same product, offered by the same or different provider.

The establishment may be a retail establishment, such as a department store, a grocery store, a convenience store, as well as other types of establishments. The party providing the POS discount card may be a company that is separate from both the establishment and the provider. The terms party, establishment, and provider are used herein to distinguish among these three entities, and no particular meaning should be inferred, or is implied, in the selection of these terms. The method 100 of FIG. 1 at least in part can be implemented as one or more computer programs stored on and/or executed from a computer-readable medium. Examples of such media include non-volatile and volatile media, magnetic media, semiconductor media, and/or optical media, as well as other types of media.

The POS discount card may represent a discounted price of the product with which it is associated. For instance, the POS discount card can represent a discount on the purchase price of the product from the provider, such as 15% off the regular price of airfare for an airplane flight, as one example. Furthermore, the POS discount card can represent a purchase price that is less than a regular purchase price of the product from the provider, such as $100-worth of airfare where the consumer only pays $50 for the item, as one example. Therefore, consumers have an incentive to purchase the POS discount cards because they can save money when purchasing the products with which the POS discount cards are associated.

The method 100 is divided into parts performed by the party providing the POS discount cards 104 and parts performed by the establishment selling the POS discount cards to consumers, as indicated by the dotted line 102. First, the party 104 provides the establishment with the POS discount cards (108), which offers the POS discount cards for sale to consumers (110). The party 104 preferably provides the establishment 106 with the POS discount cards on a consignment basis, such that the establishment 106 does not pay for the POS discount cards, and does not pay a fee to the party 104 until one or more of the cards have been sold. The party 104 may be responsible for restocking the POS discount cards at the establishment 106. The POS discount cards may be provided in traditional ways POS cards are sold at establishments, such as enclosed in shrink wrap with a piece of cardboard that can be placed on a rack, and so on.

At some point, a consumer purchases the POS discount card (112). In response, the POS discount card is electronically activated at the establishment 106 (114). That is, prior to consumer purchase of the POS discount card, the card is inactive. This means that should the card be stolen, the thief cannot use the card, so that potential for shrinkage is reduced. The discount card may have a bar code that is scanned at a POS terminal, or other POS presence, at the establishment 106 by the consumer him or herself, or by a clerk, salesperson, retail associate, and so on, to activate the card. The discount card may also have a magnetic strip so that the card is swiped at the POS terminal to activate it. Once the POS discount card has been electronically activated, the consumer may then use the card to purchase products directly from the provider of the products.

The party providing the POS discount cards 104 receives notice of the purchase and activation of the POS discount card (116). For instance, the activation process may entail a unique identifier of the POS discount card being electronically communicated from the establishment 106 to the party 104. Based on this information, the party 104 may be able to determine the sale price of the POS discount card, such as $25 for a discount of 10% off any flight offered by a given provider, or such information may have been sent to the party 104 during activation of the card. The party 104 electronically records that the POS discount card has been activated (118). For example, the party 104 may record the unique identifier of the POS discount card that has been activated, the date at which the discount card has been activated, the purchase price of the POS discount card, the type of discount and the type of product associated with the card, and/or other information regarding the discount card.

The party 104 next determines a fee that is to be paid to the party 104 based on the purchase and activation of the POS discount card (120). The fee in one embodiment is a percentage of the price the consumer paid for the POS discount card. For example, the fee may be 50% of a $25 purchase price, such that the fee is $12.50. The fee is electronically recorded by the party 104 (122). At some point in the future, the establishment 106 pays this fee to the party 104 (124), which then receives the fee (126). Therefore, in the example provided, whereas the establishment 106 receives $25 from the consumer for the POS discount card, it pays only $12.50 to the party 104, thus realizing a profit margin of 50%. As has been indicated, the establishment 106 in one embodiment does not pay anything to the party 104 for the POS discount card until a consumer has purchased the card.

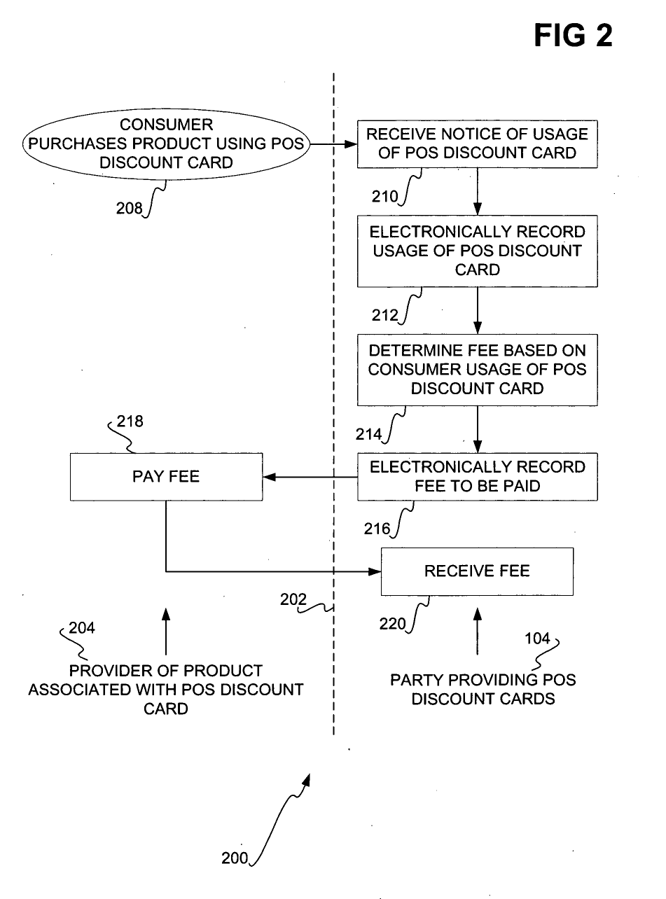

FIG. 2 shows a method 200 by which a consumer uses the POS discount card purchased within the method 100 to purchase a product associated with the card from a provider of the product, according to an embodiment of the invention. The provider of the product initially contracts with the party 104 so that the party 104 is able to manufacture the POS discount cards for agreed-upon discounts on products offered by the provider. Parts of the method 200 are performed by the provider of the product associated with the POS discount card 204, and other parts of the method 200 are performed by the party 104, as indicated by the dotted line 202. As with the method 100 of FIG. 1, the method 200 of FIG. 2 can be implemented as one or more computer programs executed from and/or stored on a computer-readable medium.

The consumer purchases a product from the provider 204 using the POS discount card it had earlier purchased from the establishment 106 in the method 100 (208). Usage of the POS discount card may entail the consumer purchasing the product directly from the provider 204, in ways dictated by the provider 204. For instance, the provider 204 may specify that the consumer has to purchase the product from an Internet web site run by the provider 204 itself, or that the consumer has to call a telephone number of the provider 204. Furthermore, the consumer may be able to use the card over the counter (OTC), in person, such as at an airline ticket counter at an airport, and so on. By specifying how the POS discount card has to be redeemed by the consumer, the provider 204 thus is able to steer the consumer to avenues of product purchase that are more profitable for the provider 204. For instance, the consumer may be forced to purchase the product from the web site of the provider 204, as opposed to a one stop-shopping web site that the consumer would ordinarily employ.

The party 104 receives notice that the POS discount card has been used by the consumer to purchase a product from the provider 204 (210). For example, electronic communication may occur between the provider 204 and the party 104, so that the provider 204 provides details regarding the usage of the POS discount card to the party 104. The party 104 then electronically records usage of the POS discount card (212). The party 104 may record a unique identifier of the POS discount card, the date at which the card was used, the type of product for which the card was used, and/or the discount realized by the consumer in using the card, as well as other information.

The party 104 next determines a fee to be paid to the party 104 based on consumer usage of the POS discount card (214). In one embodiment, the fee may be a set fee, whereas in another embodiment, the fee may be a percentage of the dollar amount of the discount realized by the consumer. For instance, if the POS discount card enables the consumer to receive $50 off a car rental from the provider 204, the fee may be determined as 10% of the $50, or $5. The party 104 electronically records the fee to be paid (216), and at some point the provider 204 pays the fee to the party 104 (218), which receives the fee (220).

It is noted that depending on the type of POS discount card, the usage, fee determination, and fee payment cycle of the method 200 may be repeated a number of times for the same POS discount card. For example, if the consumer has purchased a POS discount card worth $300 off an airline flight, he or she may be able to use $100 of that discount for a first flight, $150 of that discount for a second flight, and $50 of that discount for a third flight, until all $300 of the discount of the card has been used. Other types of POS discount cards may not be amenable to repeated usage. For example, if the consumer has purchased a POS discount card worth 20% off a car rental, the consumer may only be able to use the discount once, on a single car rental.

The party 104 that performs part of the method 100 and part of the method 200 receives fees twice for each POS discount card sold: once upon purchase and activation of the card, from the establishment 106, and once upon (each) usage of the card in purchasing a product associated with the card, from the provider 204. In one particular embodiment, fees are received only from the establishment selling the card to the consumer, pursuant to the method 100, and fees are not received from the provider providing the product associated with the card, pursuant to the method 200. That is, in this particular embodiment, only a first fee is received, from the establishment, and the second fee, from the provider, is not received. The fees received in sum, over a certain number of POS discount cards, are preferably greater than the costs incurred by the party 104 in manufacturing the cards, and in providing the electronic computer systems to track activation and usage of the cards, so that the party 104 realizes a profit. The establishment 106 almost certainly always realizes a profit, since it receives the discount cards on consignment from the party 104, and therefore does not pay any money upfront for the cards.

The provider 204 initially loses money on the sale and usage of the POS discount cards. First, the provider 204 discounts its products by a negotiated amount as represented by the POS discount cards. Second, the provider 204 pays fees to the party 104 for usage of the POS discount cards. However, the discount provided by the provider 204, and the fee provided by the provider 204, may still be less than the discounts offered to and fees paid to other avenues by which consumers may purchase products of the provider 204, such as travel agents, one stop-shopping web sites, and so on. Therefore, the net revenue received by the provider 204 may increase. Furthermore, the provider 204 may run campaigns using the POS discount cards as a way to build brand awareness, as a way to introduce or steer consumers to its web site, and so on, such that any loss may be considered an advertising expense.

Finally, consumers have an incentive to purchase and use the POS discount cards. For example, the consumer may pay $25 for a card representing a 10% discount on any flight offered by a provider. If the flight costs $500, then the discount is worth $50, so that the consumer has saved $25 by using the POS discount card. Thus, consumers purchase products from the provider 204, or seller, using the POS discount cards to obtain discounted prices on the products of the provider 204. Furthermore, it is noted that the POS discount cards, or other items, may have expiration dates, such that the consumer is to redeem or use the cards by the expiration dates printed thereon.

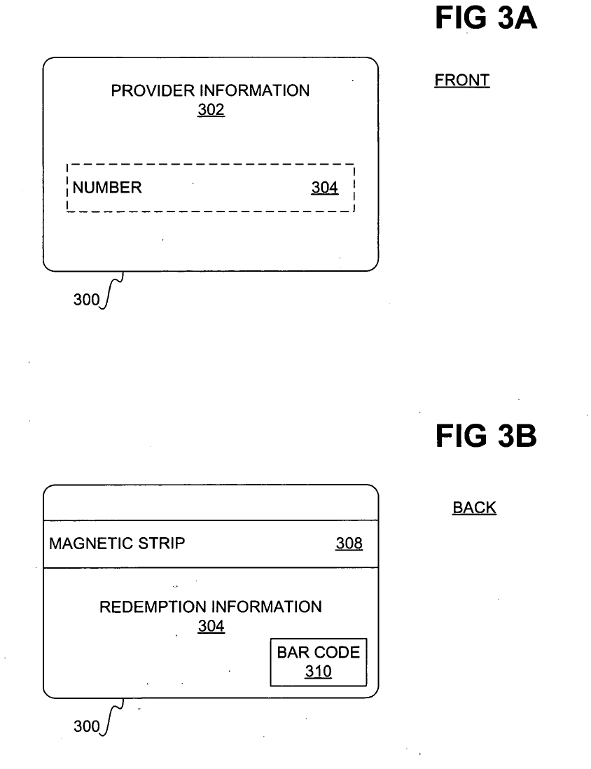

FIGS. 3A and 3B show the front and back, respectively, of a representative POS discount card 300, according to an embodiment of the invention. As has been described, the POS discount card 300 is one type of item that can be associated with a product sold by a provider or seller 204. As has also been described, the POS discount card 300 represents a discount off a product sold by the provider or seller 204, where the discount card 300 is purchased by a consumer from an establishment 106.

In FIG. 3A, the front of the POS discount card 300 includes a provider information area 302, which may include branding information of the provider 204 of the product associated with the card 300. For instance, the information area 302 may include a logo of the provider 204, the name of the provider 204, the type of discount offered, the type of product with which the discount is applicable, and so on. The front of the POS discount card 300 may also include an embossed or electronically printed number 304, which uniquely identifies the discount card 300. The number 304, which may include alphanumeric or other characters, may be entered by the consumer on the web site of the provider 204 when purchasing the product associated with the card 300 on the web site. The number 304 may also be read by the consumer to a representative of the provider 204 when purchasing the product over the phone.

In FIG. 3B, the back of the POS discount card 300 includes a redemption information area 306, which may include information regarding how the consumer is able to use the card 300 to purchase the product associated with the card 300. For instance, the information may include the web site of the provider 204, its telephone number, and so on. The information area 306 may further include any restrictions or limitations of the card 300, such as an expiration date. Either or both of the magnetic strip 308 and the bar code 310 may also be present on the back of the POS discount card 300. The magnetic strip 308 and/or the bar code 310 may encode the number 304 on the front of the POS card 300. As such, the card 300 may be swiped at a POS presence of the establishment 106 to read the magnetic strip 308 to allow the card 300 to be purchased and to activate the card 300. Similarly, the bar code 310 may be scanned at the POS presence of the establishment 106 to read the bar code 310 to allow the card 300 to be purchased and to activate the card 300. Thus, the card 300 is an electronically readable card.

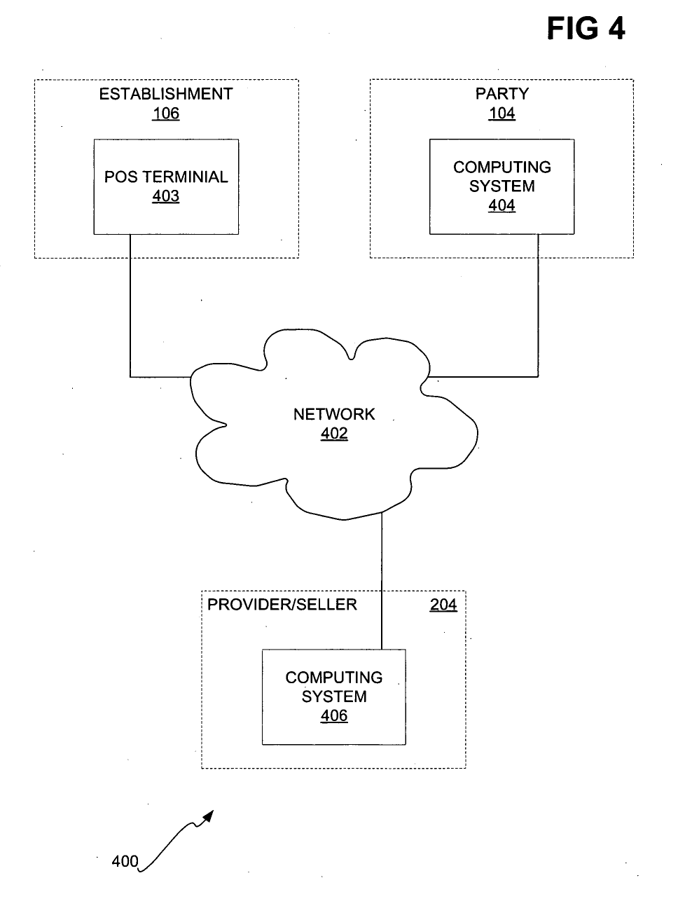

FIG. 4 shows a representative system 400 by which the methods 100 and 200 of FIGS. 1 and 2, respectively, can be implemented, according to an embodiment of the invention. The system 400 includes a network 402, a POS terminal 403 located at the establishment 106, a computing system 404 of the party 104, and a computing system 406 of the provider or seller 204. The network 402 may be or include one or more of: a wired network, a wireless network, an intranet, an extranet, the Internet, a telephony network, and so on. The POS terminal 403 is of a type that is known within the art, and communicates with the computing system 404 via the network 402. Similarly, the computing system 406 communicates with the computing system 404 via the network 402.

The POS terminal 403 located at the establishment 106 is adapted to enable sales of and to activate the POS discount cards, such as the POS discount card 300. Activation is reported by the POS terminal 403 through the network 402 to the computing system 404 of the party 104. The computing system 406 of the provider or seller 406 is adapted to enable sales of the products associated with the POS discount cards using the POS discount cards. For instance, the computing system 406 may be a web server hosting an Internet web site that is browsed to by the consumer using his or her own computing device to purchase the product. As another example, the computing system 406 may be the computing system that representatives of the provider 204 access when fielding calls by consumers to purchase products using the POS discount cards. The computing system 406 reports usage of the POS discount cards through the network 402 to the computing system 404 of the party 104.

The computing system 404 of the party 104 is thus communicatively connected to the POS terminal 403, which may be a retail POS terminal, and to the computing system 406, via the network 402 as depicted in FIG. 4, or by another mechanism. The computing system 404 is adapted to record activation of the POS discount cards at the POS terminal 403, and to record usage of the POS discount cards via the computing system 406 of the provider or seller 204. The computing system 404 is further adapted to determine a fee payable to the party 104 by the establishment 106 based on the purchase and activation of the POS cards, and a fee payable to the party 104 by the provider 204 based on the subsequent usage of the POS cards.

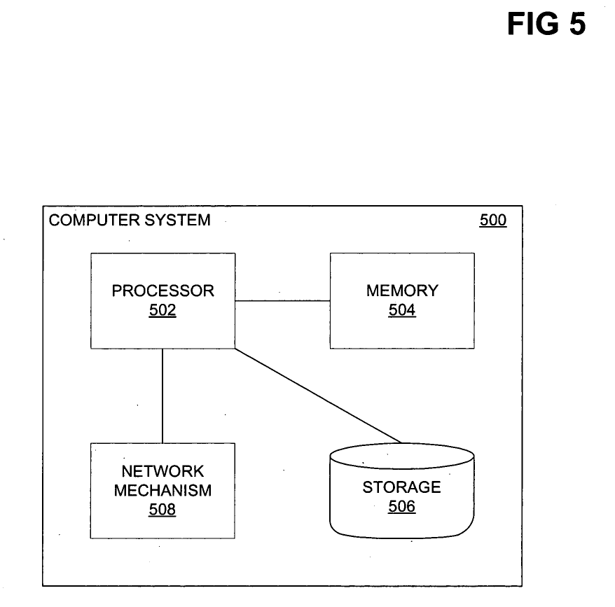

FIG. 5 shows a representative computer system 500, which can implement either or both of the computing system 404 and the computing system 406, according to an embodiment of the invention. The computing system 500 includes a processor 502, memory 504, storage 506, and a network mechanism 508. As can be appreciated by those of ordinary skill within the art, the system 500 may include components in addition to and/or in lieu of those depicted in FIG. 5. The processor is communicatively connected to the memory 504, the storage 506, and the network mechanism 508. The computing system 500 may be implemented as one or more computing devices, such as one or more server computers, desktop computers, and so on.

The processor 502 is able to perform at least some parts of the methods 100 and 200 of FIGS. 1 and 2, respectively. The processor 502 thus executes computer instructions that are part of a computer program that may be permanently stored on the storage 506, and which may be executed from the memory 504. The memory 504 is typically volatile semiconductor memory, such as random-access memory, and is used by the processor 502 to temporarily store data needed during execution of computer programs.

By comparison, the storage 506 is typically non-volatile magnetic media, such as a hard disk drive, and is used by the processor 502 to more permanently store computer programs, data received, and data generated. For instance, where the system 500 implements the system 404 of FIG. 4, the storage 506 may store information regarding POS discount cards that are activated, as well as information regarding POS discount cards that are used. As another example, where the system 500 implements the system 404 of FIG. 4, the storage 506 may store the fees determined by the processor 502 to be paid to the party 104.

Finally, the network mechanism 508 enables the computing system 500 to communicate over the network 402 of FIG. 4. The network mechanism 508 may be or include a network adapter card, and so on. Thus, where the computer system 500 implements the computer system 404 of FIG. 4, the network mechanism 508 enables the receipt of notices of activation of POS discount cards from the POS terminal 403 of the establishment 106. Similarly, where the system 500 implements the system 404 of FIG. 4, the network mechanism 508 enables the receipt of notices of usage of POS discount cards from the computing system 406 of the provider or seller 204.

It is noted that, although specific embodiments have been illustrated and described herein, it will be appreciated by those of ordinary skill in the art that any arrangement calculated to achieve the same purpose may be substituted for the specific embodiments shown. For instance, whereas embodiments of the invention have been substantially described in relation to products that are travel-related products and services, other embodiments of the invention may be implemented in relation to products that are not travel-related products and services. As another example, whereas embodiments have been substantially described in relation to POS cards, other embodiments of the invention may be implemented in relation to items that are not POS cards. This application is thus intended to cover any adaptations or variations of embodiments of the present invention. It is manifestly intended that this invention be limited only by the claims and equivalents thereof.

1. A method comprising:
providing an establishment with an item associated with a product and representing one of: a discount on a purchase price of the product from a provider, and a purchase price of at least part of the product less than a regular purchase price of at least the part of the product from the provider;
in response to a consumer purchasing the item from the establishment, and in response to the item being activated, receiving a first fee from the establishment; and,
in response to the consumer purchasing the product from the provider using the item, receiving a second fee from the provider.

2. The method of claim 1, wherein providing the establishment with the item comprises providing the establishment with an electronically readable card.

3. The method of claim 1, wherein the item represents one of: a discount on a purchase price of a service from a provider, and a purchase price of at least part of a service less than a regular purchase price of at least the part of the service from a provider.

4. The method of claim 1, wherein the consumer purchasing the item from the establishment comprises the consumer purchasing the item at a point-of-sale presence of the establishment.

5. The method of claim 1, wherein the item being activated comprises the item being activated at the establishment, such that prior to activation the item is inactive and unable to be used by the consumer to purchase the product.

6. The method of claim 1, wherein the consumer purchasing the product from the provider using the item comprises the consumer purchasing the product at an Internet web site of the provider.

7. The method of claim 1, wherein the consumer purchasing the product from the provider using the item comprises the consumer purchasing the product by calling a telephone number of the provider.

8. The method of claim 1, wherein the consumer purchasing the product from the provider using the item comprises the consumer purchasing the product over a counter of the provider, in person.

9. The method of claim 1, wherein the consumer purchasing the product from the provider using the item comprises the consumer purchasing the product from the provider using a portion of the item, such that receiving the second fee comprises receiving a portion of the second fee.

10. The method of claim 9, further comprising, in response to the consumer purchasing another product from the provider using another portion of the item, receiving another portion of the second fee from the provider.

11. A method comprising:
a first party supplying point-of-sale (POS)-activated items to an establishment having one or more POS terminals;
selling the POS-activated items by the establishment to consumers;
activating the POS-activated items at the POS terminals of the establishment; and,
the first party receiving a first fee per POS-activated item based on the sale of the POS-activated items by the establishment.

12. The method of claim 11, further comprising:
the consumers using the items against purchases from a seller; and,
the first party receiving a second fee based on purchases from the seller using the items by the consumers.

13. The method of claim 11, wherein the POS-activated items are associated with products from the seller, and represent one of: a discount on a purchase price of one of the products from the seller; and, a purchase price of at least part of one of the products less than a regular purchase price of at least the part of one of the products from the seller.

14. The method of claim 11, wherein the consumers using the items against purchases from the seller comprises the consumers purchasing products from the seller using the items to obtain discounted prices on the products.

15. The method of claim 11, wherein the consumers using the items against purchases from the seller comprises at least one of: the consumers purchasing products from the seller at an Internet web site of the seller; and, the consumers purchasing products from the seller by calling a telephone number of the seller.

16. A method comprising:
in response to a consumer purchasing, at an establishment, an item associated with a product and representing a discounted price of the product from a provider, electronically activating the item at the establishment before the consumer receives the item;
electronically recording activation of the item and a corresponding value of the item; and,
determining a first fee payable to a first party based on activation of the item.

17. The method of claim 16, further comprising:
in response to a consumer using the item to purchase the product directly from the provider, electronically recording usage of the item; and,
determining a second fee payable to the first party based on usage of the item to purchase the product.

18. The method of claim 16, further comprising paying the first fee by the establishment to the first party.

19. The method of claim 17, further comprising paying the second fee by the provider to the first party.

20. The method of claim 16, wherein the product from the provider is one of a travel-related product and a travel-related service.

21. The method of claim 16, wherein the item comprises a plurality of electronically readable cards.

22. A system comprising:
a retail point-of-sale (POS) terminal at an establishment and adapted to enable sales of and to activate POS items representing discounted prices of products from a seller;
a computing system of the seller adapted to enable sales of the products using the POS items; and,
a computing system of a first party communicatively connected to the retail POS terminal and to the computing system of the seller, the computing system of the first party adapted to record activation of the POS items at the retail POS terminal and to record usage of the POS items,
the computing system of the first party further adapted to determined a first fee payable to a first party based on the activation of the POS items and a second fee payable to the first party based on the usage of the POS items.

23. The system of claim 22, wherein the POS items are electronically readable cards.

24. The system of claim 22, wherein each POS item comprises a plurality of electronically readable cards.

25. The system of claim 22, wherein the products from the seller having the discounted prices represented by the POS items comprise services provided by the seller.

26. A computer-readable medium having a computer program stored thereon comprising:
means for receiving notice of activation of an item at an establishment, the item associated with a product of a provider and representing a discounted price of the product;
means for determining a first fee payable by the establishment to a first party upon activation of the item;
means for receiving notice of usage of the item in purchase of the product of the provider; and,
means for determining a second fee payable by the provider to the first party upon usage of the item in purchase of the product.

27. The computer-readable medium of claim 26, wherein the means for receiving notice of usage of the item is for receiving notice of usage of the item in purchase of the product directly from the provider.

28. The computer-readable medium of claim 26, wherein the item represents one of: a discount on a purchase price of the product from the provider, and a purchase price of at least part of the product less than a regular purchase price of at least the part of the product from the provider.

29. The computer-readable medium of claim 26, wherein the product of the provider comprises a service offered by the provider.

30. The computer-readable medium of claim 26, wherein the item is an electronically readable point-of-sale (POS) card.

31. A method comprising:
providing an establishment with an item associated with a product and representing one of: a discount on a purchase price of the product from a provider, and a purchase price of at least part of the product less than a regular purchase price of at least the part of the product from the provider; and,
in response to a consumer purchasing the item from the establishment, and in response to the item being activated, receiving a first fee from the establishment.

32. The method of claim 31, wherein the item represents one of: a discount on a purchase price of a service from a provider, and a purchase price of at least part of a service less than a regular purchase price of at least the part of the service from a provider.

33. The method of claim 31, wherein the consumer purchasing the item from the establishment comprises the consumer purchasing the item at a point-of-sale presence of the establishment.

34. The method of claim 31, wherein the item being activated comprises the item being activated at the establishment, such that prior to activation the item is inactive and unable to be used by the consumer to purchase the product.
